(19) United States
(12) Patent Application Publication
(10) Pub. No.: US 2015/0103093 A1
(43) Pub. Date: Apr. 16, 2015

(54) System and Method for Displaying Image Data on a Vectorscope

(71) Applicant: Apple Inc., Cupertino, CA (US)

(72) Inventors: Andrew E. Bryant, Los Gatos, CA (US); Peter Warner, Paris (FR); Ryan A. Gallagher, San Jose, CA (US)

(73) Assignee: Apple Inc., Cupertino, CA (US)

(21) Appl. No.: 14/053,583

(22) Filed: Oct. 14, 2013

(51) Int. Cl. G06T 11/00

(52) U.S. Cl. CPC G06T 11/001
USPC 345/595

(57) ABSTRACT

An image organizing and editing application receives and edits the colors of a target image in relation to the colors of a reference image. The application displays vectorscope representations of the colors of a target image and the colors of a reference image. The application receives adjustments to the vectorscope representation of the target image and adjusts the colors of the target image according to the received adjustments to the representation.

### BACKGROUND

Digital images sometimes have an undesirable tint to them. In some cases, the light used when capturing the image may have been a particular color (e.g., blue) that is not wanted as a tint for the final image. In other cases an image may be received as a scan from an old photograph that has yellowed over time. In still other cases, images of the same person or scene taken by different cameras may have different color qualities because of differences between the cameras. Regardless of the reason for a need to change the colors of an image, image editing applications include controls for adjusting the colors of an image. One type of color editing involves taking an image defined in a color space with luminance and chrominance components and rotating the chrominance components of the image. Such a rotation can change the tint of an object in the image. However, in cases where a given final tint is desired (e.g., when two images of the same person or separate images of two people are required to have the same skin tone as each other) it is difficult to tell purely by looking at the images that the adjusted color has the proper relationship with the desired color.

### BRIEF SUMMARY

In some embodiments, an application (e.g., an image organizing and editing application) receives and edits the colors of a target image in relation to the colors of a reference image. For example, the applications of some embodiments display vectorscope representations of the colors of a target image and the colors of a reference image. The application receives adjustments to the vectorscope representation of the target image and adjusts the colors of the target image according to the received adjustments to the representation. For example, an application receives commands to rotate and/or rescale the representation of the target image in order to more closely match the representation of the reference image. The application adjusts the colors of the target image in accord with the rotation and rescaling of the representation of the target image.

Each pixel in an image can be represented in a luminance/chrominance color system (e.g., a YC_{b}Cᵣ color component system) by a luminance value Y and two chrominance values. The applications of some embodiments provide a vectorscope representation of images that represents the chromatic values of the pixels of the images on a two-dimensional plot. In one direction, the vectorscope displays a first chromatic component (e.g., C_{b} of a YC_{b}Cᵣ color component system) while in another direction the vectorscope displays a second chromatic component (e.g., Cᵣ of a YC_{b}Cᵣ color component system). In some embodiments, the directions are orthogonal. In other embodiments, the directions are not orthogonal. Each pixel in an image can be represented by a location on the vectorscope based on its two chrominance values. In some cases, multiple pixels in the image (i.e., pixels that are each representing a different area of the image, but that are close in chrominance values) may be represented by a single pixel of the vectorscope display. For example, when the scale of the vectorscope is too small to represent each possible color in the image with its own pixel, the chromatic values of multiple pixels in the image may correspond to a single pixel of the vectorscope.

In some embodiments, the application allows the user to make adjustments directly to a vectorscope representation of an image. The adjustments in some embodiments include one or more of rotation, rescaling, and translation (i.e., moving the entire vectorscope representation without rotating or rescaling it). Upon receiving commands to modify the vectorscope representation of an image, the applications of some embodiments adjust the colors of the corresponding pixels in the image to match the adjustments to the vectorscope representation. For example, if rotating a vectorscope representation moves a pixel of the vectorscope representation from the blue area of the vectorscope to the red area of the vectorscope, then the pixels in the image that correspond to that pixel in the vectorscope representation will change from blue to red.

The applications of some embodiments display vectorscope representations of both a reference image and a target image on the same vectorscope. By displaying the vectorscope representations of both images on the same vectorscope, the application of such embodiments allows a user to adjust the colors of the target image while viewing the vectorscope representation of the reference image.

The applications of some embodiments, in addition to providing vectorscopes that display representations of the colors of the entire image, also allow a user to select a particular location on the image. The application then marks the location on the vectorscope corresponding to the color of that location. Such a mark is sometimes called a “color mark”, herein. In some such embodiments, the user is able to select the color mark and rotate and/or rescale the vectorscope representation by moving the color mark. In some embodiments, the application further provides a line from the center of the vectorscope (or the location where the chrominance component values are both zero, if that location is not at the center of the vectorscope) through the color mark in order to show which portions of the vectorscope have the same ratio of chrominance values as the selected location. In some embodiments, only the vectorscope representation of the target image gets a color mark and/or a color line. In other embodiments, both the target vectorscope representation and the reference vectorscope representation simultaneously display color marks and color lines based on selected locations in each image.

In some embodiments, the target vectorscope representation and the reference vectorscope representation are displayed in two different colors or in two different color schemes. One advantage to displaying the vectorscope representations in different colors is that the user can easily distinguish the source representation from the target representation.

Although the figures herein show a target vectorscope representation together with either a single reference vectorscope representation or no reference vectorscope representation, in some embodiments, multiple reference vectorscope representations may be shown on the same vectorscope as a target vectorscope representation. In some embodiments, each reference vectorscope representation and the target vectorscope representation are displayed in a different color.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE FIGURES

The novel features of the invention are set forth in the appended claims. However, for purpose of explanation, several embodiments of the invention are set forth in the following figures.

FIG. 1 illustrates the use of an overlapped vectorscope of some embodiments.

FIG. 2 conceptually illustrates a process of some embodiments for adjusting the colors of an image using a vectorscope.

FIG. 3 conceptually illustrates a process of some embodiments for applying vectorscope related functions to an image.

FIG. 4A illustrates color rotation of images using a vectorscope representation.

FIG. 4B illustrates color adjustment of images through rescaling and translation of a vectorscope representation.

FIG. 5A illustrates an application of some embodiments displaying vectorscopes of a reference image and a target image.

FIG. 5B illustrates an overlapped vectorscope of some embodiments.

FIG. 6 conceptually illustrates a process of some embodiments for displaying an overlapped vectorscope while adjusting an image.

FIG. 7 illustrates the adjustment of an image in response to a command to adjust a target vectorscope representation.

FIG. 8 illustrates an application of some embodiments that provides a control for automatically synchronizing chrominance components (e.g., C_{b} and Cᵣ).

FIG. 9 illustrates the use of an overlapped vectorscope to receive a command to translate a vectorscope representation laterally.

FIG. 10 illustrates a control for visually rescaling (i.e., zooming in on) the vectorscope representations.

FIG. 11 illustrates a control for adjusting the brightness of the vectorscope representations.

FIG. 12 is an example of an architecture of a mobile computing device on which some embodiments are implemented.

FIG. 13 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to be identical to the embodiments set forth and that the invention may be practiced without some of the specific details and examples discussed. It will be clear to one of ordinary skill in the art that various controls depicted in the figures are examples of controls provided for reasons of clarity. Other embodiments may use other controls while remaining within the scope of the present embodiment. For example, a control depicted herein as a hardware control may be provided as a software icon control in some embodiments, or vice versa. Similarly, the embodiments are not limited to the various indicators depicted in the figures. For example, in some embodiments, the vectorscope could use a circular color representation rather than a hexagon, the colors of vectorscope representations of source and target images could be different, etc.

In some embodiments, an application (e.g., an image organizing and editing application) receives and edits image data of a target image to provide a relationship between the color of an item in the target image and the color of an item in a reference image (sometimes called a “source image”). For example, the applications of some embodiments receive a selection of a location in the reference image and provide a user with GUI tools to allow the user to adjust the colors of the target image to match (or almost match, or oppose, as the user desires) the colors of the reference image. In order to do this, the application of some embodiments employs vectorscope representations of the reference image and target image.

Each pixel in an image can be represented in a luminance/chrominance color system (e.g., a YC_{b}Cᵣ color component system) by a luminance value Y and two chrominance values. The applications of some embodiments provide a vectorscope representation of images that represents the paired chrominance values of the image on a two-dimensional plot. In one direction, the vectorscope displays a first chromatic component (e.g., C_{b} of a YC_{b}Cᵣ color component system) while in another direction the vectorscope displays a second chromatic component (e.g., Cᵣ of a YC_{b}Cᵣ color component system). In some embodiments, the directions are orthogonal. In other embodiments, the directions are not orthogonal. Each pixel in an image can be represented on the vectorscope based on its two chrominance values.

In some embodiments, the application automatically makes the color adjustments to a target image upon selection of the reference color in the reference image. In order to do so, the application of some embodiments synchronizes the vectorscope representations of the target image and the reference image through rotation, rescaling, and/or translation of the vectorscope representation of the target image. In some other embodiments the application allows the user to make adjustments directly to a vectorscope representation of an image. In some such embodiments the user selects a particular location on the image and the application marks (with a “color mark”) the location on the vectorscope corresponding to the color of that location. The user then rotates, rescales, and/or translates the vectorscope representation by selection and moving the color mark.

In some embodiments, the image editing, viewing, and organizing applications provide vectorscope representations of both a reference image and a target image simultaneously. In some such embodiments the application displays the vectorscope representations in separate colors (e.g., one representation is blue and the other representation is yellow). The application displays the different colored representation as overlapping. In some such embodiments, the application displays overlapping portions of the representation in a third color. In other such embodiments, the application displays the overlapping portions in the color of one of the representations.

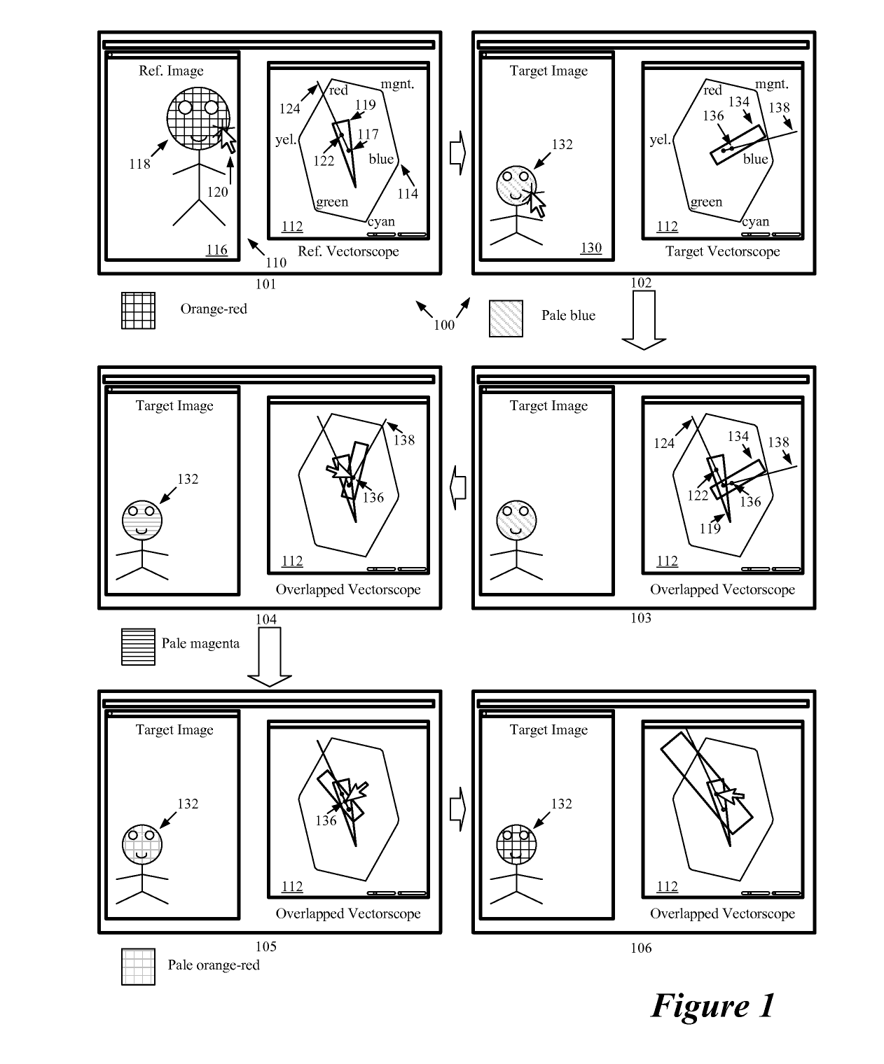

FIG. 1 illustrates the use of an overlapped vectorscope of some embodiments. The figure is illustrated in six stages 101-106. Each stage 101-106 depicts a graphical user interface 100 of an image editing, viewing, and organizing application. The figure is a simplified introductory figure and does not show all features of some embodiments.

The graphical user interface 100 includes an image window 110 and a vectorscope 112. The vectorscope 112 displays a representation in a particular color space of the colors of an image. In the embodiments of FIG. 1, the vectorscope 112 displays the C_{b} and Cᵣ components of the pixels after the pixels have been translated into a YC_{b}Cᵣ color space. The C_{b} and Cᵣ components are sometimes called the “chrominance components” of the pixel, while the Y component is sometimes called a “luminance component” of the pixel.

In some embodiments, each different possible C_{b} and Cᵣ component combination is represented by a location on the vectorscope 112. The more saturated a pixel in the image is with a particular color (e.g., the higher the absolute values of the C_{b} and Cᵣ components of the pixel are), the closer the corresponding point on the vectorscope is to the corner representing that color. For example, if a pixel is primarily blue (i.e., the pixel has a very high C_{b} component value and a value close to zero for the Cᵣ component), the corresponding point on the vectorscope 112 will be close to the blue corner 114. In contrast, if a pixel is completely neutral (i.e., C_{b} and Cᵣ are both zero, as in black, white, or neutral gray pixels), then the corresponding point of the vectorscope 112 would be the center of the scope. One of ordinary skill in the art will realize that, because the Y component is not plotted on the vectorscope, some locations on the vectorscope represent multiple pixels with different Y component values but the same C_{b} and Cᵣ component values.

Plotting an actual image's colors on a vectorscope 112 generally yields an amorphous form on the vectorscope 112. In some embodiments, the amorphous form can be non-contiguous for some images. For ease in distinguishing vectorscope 112 representations of the images in the figures described herein, the vectorscope representations have been given more regular forms (a triangle and a rectangle). However, one of ordinary skill in the art will realize that regular shapes on a vectorscope 112 representation of a real image would be unusual.

In stage 101, the image 116 in the image window 110 is a stylized image of an adult with a face 118. In this stage 101, the C_{b} and Cᵣ components of the colors of the image have been plotted on the vectorscope 112 and the aggregate of those plots is represented by a triangle, which is vectorscope representation 119. Through a combination of factors such as lighting color, the color of the skin of the individual, and any previous editing done to the image, the face 118 is a moderately saturated orange-red color. In stage 101, a user selects a part of the face with a cursor 120. In some embodiments, a user selects part of the face by moving a cursor control device to the desired location and clicking on the desired location. In some embodiments other controls can be used to select part of the image instead of or in addition to a cursor control device (e.g., a touch on a touch sensitive screen).

In the illustrated embodiment, the color of the selected portion of the face 118 is then indicated on the vectorscope 112 with a color mark 122. The color mark 122 is intersected by a color line 124 from the center 117 of the vectorscope 112. The color line 124 indicates the set of colors with the same ratio of C_{b} component value to Cᵣ component value as the selected pixel. The distance from the center 117 to color mark 122 indicates the saturation of the pixel with color. The greater the distance of the color mark 122 from the center of the vectorscope 112, the more saturated the color of the selected pixel is.

The image 116 in stage 101 is a reference image and the selected color indicated by color mark 122 is a reference color of the reference image. In some embodiments, the reference image is selected by a toggle control (e.g., a control on a pull down menu). The reference image is selected by the order in which the images are loaded, in other embodiments. In some embodiments the reference image is selected by use of a hotkey, or some other command from a user interface device. The applications of some embodiments provide multiple methods for selecting a reference image.

After the reference image 116 and reference color of the reference image have been selected, the user loads target image 130, which is shown in stage 102. The target image 130 is of a child with a face 132. Due to a combination of factors such as skin color, lighting, and previous editing, the face 132 is a pale blue color. The C_{b} and Cᵣ components of the colors of the image 130 have been plotted on the vectorscope 112 and the aggregate of those plots is represented by a rectangle, which is vectorscope representation 134.

In this stage 102, the cursor 120 is selecting a portion (e.g., a pixel) of face 132. The C_{b} and Cᵣ components of the color of the selected portion of image 130 are represented on the vectorscope 112 by color mark 136. Color line 138 represents the set of colors with the same ratio of C_{b} component values to Cᵣ component values as the selected pixel.

Stage 103 shows the vectorscope 112 with overlapping plots. Both the vectorscope representation 119, representing the colors of the reference image 116, and the vectorscope representation 134, representing the colors of target image 130, are present simultaneously. In some embodiments, the application displays the reference plot (here, vectorscope representation 119) in a first color (e.g., blue), displays the target plot (here, vectorscope representation 134) in a second color (e.g., yellow), and displays overlapping areas on the vectorscope in a third color (e.g., green). In other embodiments, the application displays the target and reference plots in different colors, but displays overlapping areas in the color of one of the plots (e.g., overlapping areas of the vectorscope representations on the vectorscope are the same color as the color of the vectorscope representation of the target image).

By overlapping the target plot and the reference plot, the application shows the user how the bulk of the C_{b}/Cᵣ values of one image differ from that of the other image. Here, image 116 is predominantly shades of orange-red, as shown by the large portion of vectorscope representation 119 in a section of the vectorscope toward the red corner and slightly toward yellow. Image 130 is predominantly blue with a touch of magenta, as shown by the large portion of the vectorscope representation 134 near the blue corner and slightly shifted toward the magenta corner.

In the illustrated embodiment, the reference color selected from reference image 116 is still represented in stage 103 on the overlapped vectorscope 112 by color mark 122 and color line 124. Similarly, the color mark 136 and color line 138 represent a reference color selected from target image 130. However, in some embodiments, the color mark and color line representing the reference color selected from target image are displayed on the overlapped vectorscope, but the color mark and color line representing the reference color of the reference image are not displayed on the overlapped vectorscope. As used herein, the color mark and the color line will be displayed on overlapped vectorscopes of the figure to indicate the C_{b} and Cᵣ values of the reference locations of the reference images. However, some embodiments do not require that a reference location of a reference image be selected and/or do not display a color mark and color line for the reference image on the overlapped vectorscope.

In some embodiments, a user can select the color mark representing the reference color of the target image and drag the color mark to change the reference color. In some such embodiments, dragging the color mark around the center of the vectorscope causes the plotted representation of the colors of the target image to rotate. In addition, the colors of some or all pixels in the image rotate in color space in accord with the rotated vectorscope representation. At some point between stages 103 and 104, the user has selected the color mark 136 and has dragged it from the position it is in during stage 103, around the center of the vectorscope 112, to the position it is in during stage 104.

In stage 104, the vectorscope representation 134 has rotated about the center of the vectorscope 112 and the image 130 has changed accordingly. The face 132 of the child in image 130 has changed from pale blue to pale magenta in accord with the new position of the color line 138 (i.e., through the magenta corner of the vectorscope 112) and the position of the color mark 136 along that line (i.e., relatively close to the center of the vectorscope 112).

In stage 105, the vectorscope representation 134 has been rotated farther until the color line 136 is aligned with color line 124. Accordingly, the color of the face 132 of the child in image 130 has changed to an orange-red color. The alignment of the color lines 124 and 138 indicates that the ratio of C_{b} to Cᵣ of the reference location of the image 130 is the same as the ratio of C_{b} to Cᵣ of the reference image 116. However, in stage 105, the face 132 is a pale orange-red, rather than the same orange-red as the reference location of image 116 (i.e., in face 118). This is because the representative color mark 136 is closer to the center of the vectorscope 112 than the color mark 122. The closer proximity to the center of the vectorscope 112 indicates lower absolute values of C_{b} and Cᵣ.

In stage 106, the color mark 136 has been moved outward to the same distance from the center of the vectorscope 112 as the color mark 122. In this stage, color marks 136 and 122 are at the same position, indicating that the C_{b} and Cᵣ values of the reference location of the target image 130 have been changed to match the C_{b} and Cᵣ values of the reference location of the reference image 116. The change in the saturation of the color of the reference location of the target image 130 is indicated by the color of the face 132 changing from pale orange-red (in stage 105) to orange-red (in stage 106). However, one of ordinary skill in the art will realize that the identical C_{b} and Cᵣ values, by themselves, do not guarantee that the color of the reference location of the target image 130 will be identical to the color of the reference location of the reference image 116. If the locations have identical Y values as well as the newly identical C_{b} and Cᵣ values, then the colors of the locations will be identical as well.

In the illustrated embodiments, in stage 106, the act of moving the color mark 136 away from the center of the vectorscope 112 causes the vectorscope representation of image 130 (i.e., vectorscope representation 134) to rescale. This rescaling moves every point of the vectorscope representation 134 further from the center of the vectorscope 112. All the colors (that are not already fully saturated) of the image 130 become more saturated accordingly. However, in other embodiments, moving the color mark 136 will cause the vectorscope representation 134 to stretch only along the axis of the movement away from the center (e.g., the representation will elongate along the direction of color line 138) and change the colors of the image 130 accordingly.

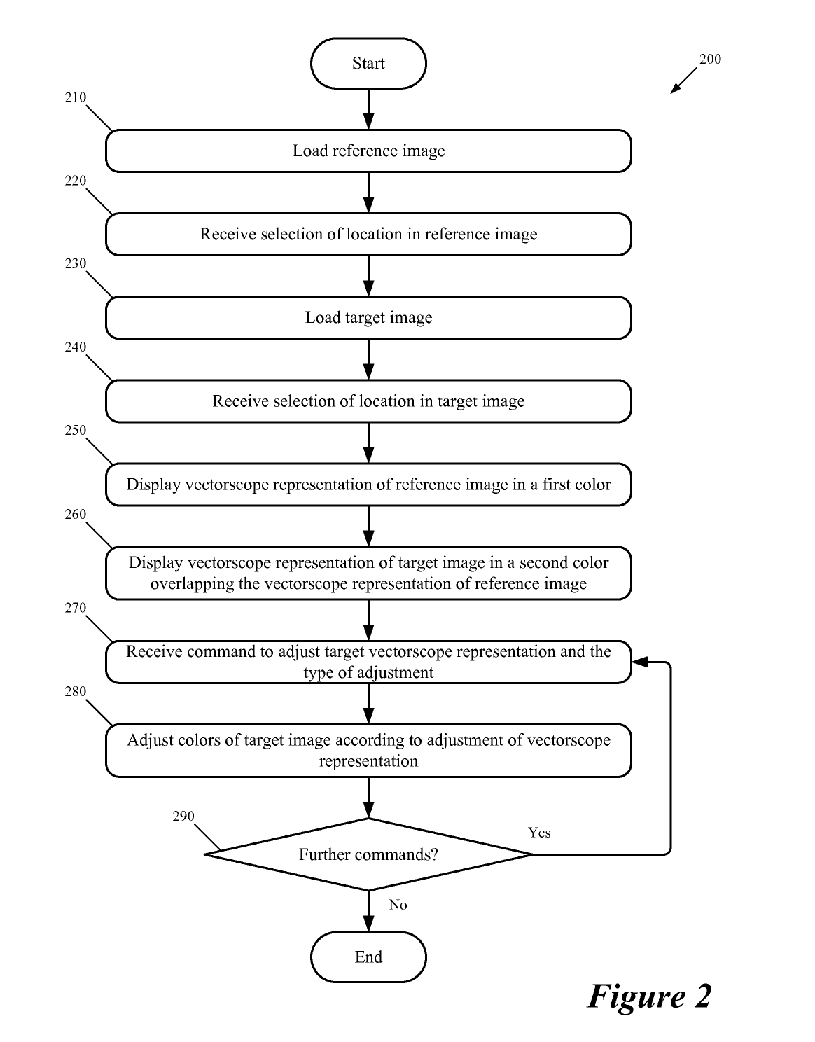

FIG. 2 conceptually illustrates a process 200 of some embodiments for adjusting the colors of an image using a vectorscope. The process 200 loads (at 210) a reference image. The reference image could be an image captured by a camera or scanner, or could be simulated, or partly real and partly simulated. The process 200 then receives (at 220) a selection of a location in the reference image. In some embodiments, this operation is not performed. In other embodiments, the application provides a user with an option to select a location in the reference image, but does not require a selection of a location in the reference image. In some such embodiments, the application could still display a vectorscope representation of the reference image, either alone or with an overlapping target vectorscope representation. However the reference vectorscope representation would not be displayed with a color mark and color reference line if a location on the reference image was not selected.

The process 200 then loads (at 230) a target image. In some embodiments, the target image and the reference image can be loaded at any time and in any order and the selection of which image is the target image can be changed by the receipt of a user command to change the reference image. The process 200 then receives (at 240) a selection of a location in the target image. In some embodiments, this operation is not performed. In other embodiments, the application provides a user with an option to select a location in the target image, but does not require a selection of a location in the target image. When no selection is made, in some embodiments, a color mark and color line for the target image are not displayed on the vectorscope. In some such embodiments, the application still receives commands that affect the colors of the target image in response to adjustments (e.g., rotation, etc.) to the target vectorscope representation. However, those commands do not include selection (e.g., clicks) of the color mark or color line when no location of the target image is selected.

The process 200 then displays (at 250) a vectorscope representation of the reference image in a first color (e.g., blue). The process 200 also displays (at 260) a vectorscope representation of the target image in a second color (e.g., yellow) on the same vectorscope as the vectorscope representation of the reference image. In some embodiments, portions of the vectorscope representations overlap one another. In some embodiments, the overlapping portions of the vectorscope representations are displayed in a third color (e.g., green). In other embodiments, the overlapping portions of the vectorscope representations are displayed in the color of one of the two representations (e.g., the target representation overlays the reference representation or the reference representation overlays the target representation).

The process 200 then receives (at 270) a command to adjust the target vectorscope representation and the type of adjustment. In some embodiments, the type of adjustment is a command to rotate the vectorscope representation about the center of the vectorscope. In other embodiments, the type of adjustment in the received command is to rescale the vectorscope representation. The command is a command to move the vectorscope representation in a particular direction (e.g., up, down, left, right, or some combination of those directions) in some embodiments. In some embodiments the received command is a command to stretch or warp the vectorscope representation. The types of commands described above are not mutually exclusive. For example, in some embodiments the process receives a command to simultaneously rotate and rescale the vectorscope representation. Some embodiments receive multiple commands in sequence (e.g., rotate, rescale, and then translate).

After receiving a command to adjust the target vectorscope representation, the process 200 adjusts (at 280) the colors of the target image according to the adjustment of the vectorscope representation. For example, if the vectorscope representation is rotated about the center of the vectorscope, the process 200 adjusts the colors of the target image by rotating the C_{b} and Cᵣ values of the pixels in the image through YC_{b}Cᵣ space. The process 200 then determines (at 290) whether further commands are forthcoming (e.g., whether the target image is still open for editing). If further commands are forthcoming, the process 200 loops back to operation to receive (at 270) the further commands. If no further commands are forthcoming (at 290) then the process 200 ends.

The process of some embodiments for adjusting the color of an image using a vectorscope and the use of overlapping vectorscope representations of some embodiments were discussed above. Below several more details of different embodiments of the invention are described in the following sections. Section I describes the vectorscope functions of some embodiments. Section II describes an overlapped vectorscope that displays vectorscope representations of both a reference image and a target image. Section III then describes controls that affect the vectorscope display. Section IV describes a mobile device used to implement applications of some embodiments. Section V describes a computer system used to implement applications of some embodiments.

### I. Vectorscope Functions

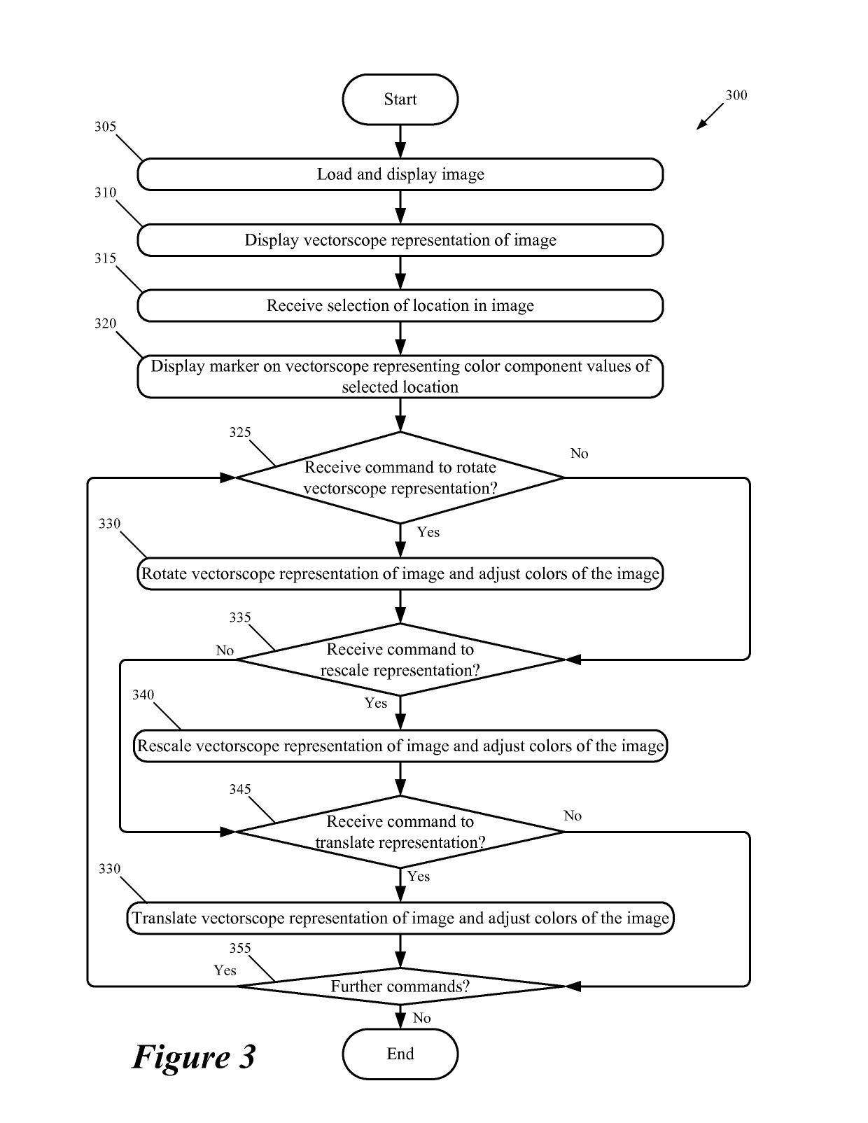

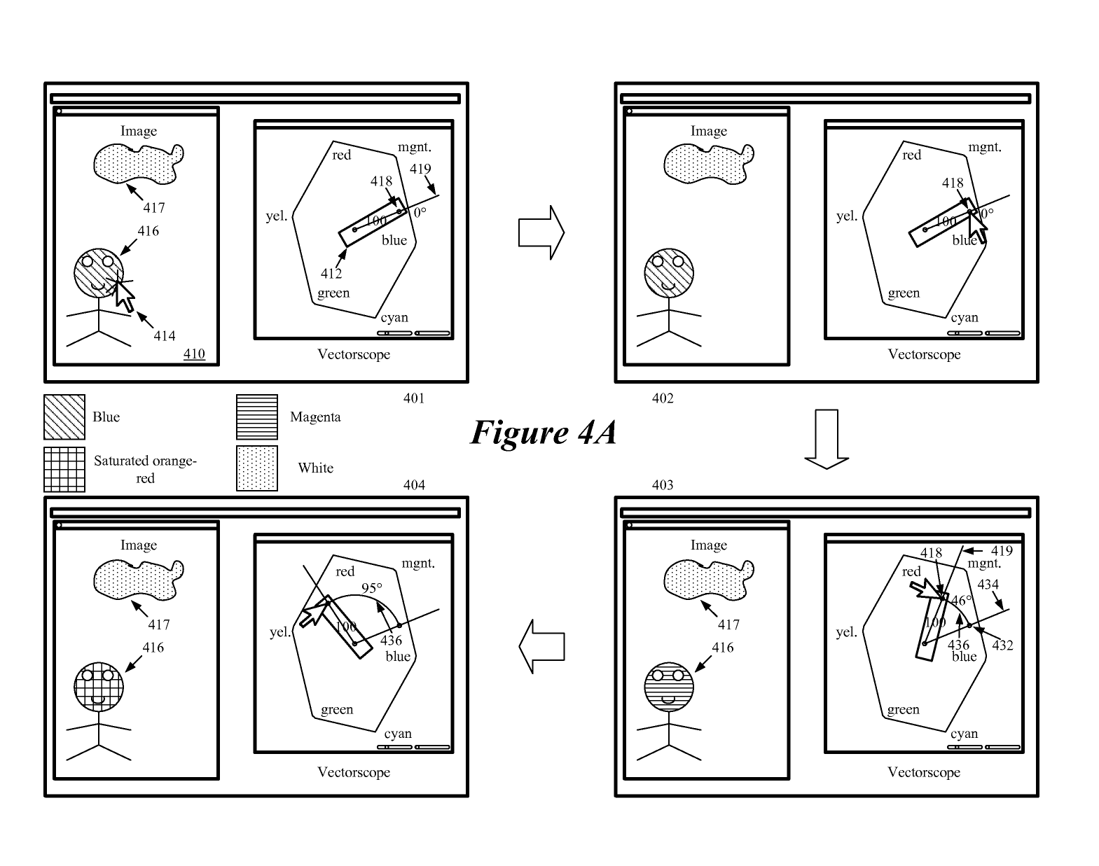

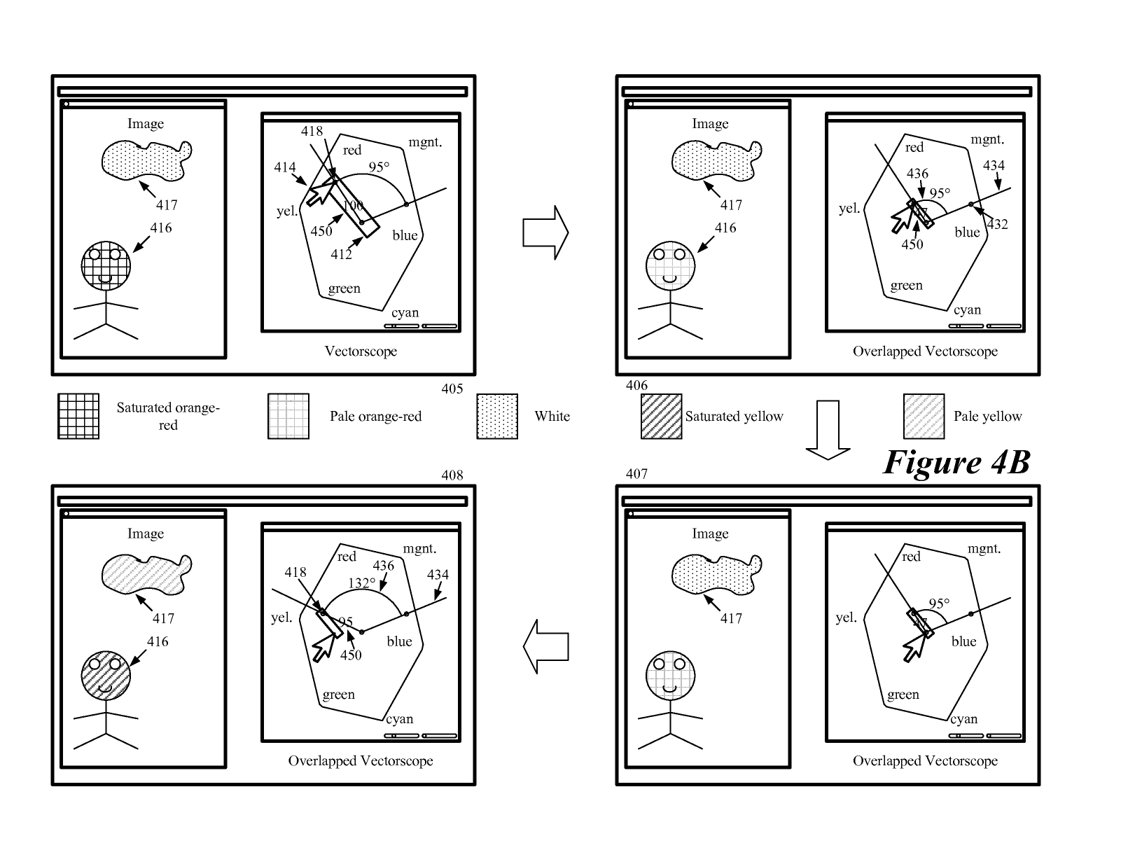

Before section II describes the more complicated displays of overlapped vectorscopes, this section describes some vectorscope related functions performed on a single image by image editing, viewing, and organizing applications of some embodiments. FIG. 3 conceptually illustrates a process 300 of some embodiments for applying vectorscope related functions to an image. Some examples of various operations of FIG. 3 will be described with respect to FIGS. 4A-4B. FIG. 4A illustrates color rotation of images using a vectorscope representation. FIG. 4B illustrates color adjustment of images through rescaling and translation of a vectorscope representation.

The process 300 loads and displays (at 305) an image. In some embodiments, the image can be any type of digital image. An example of such an image is image 410 of FIG. 4A. The process 300 then displays (at 310) a vectorscope representation of the image. In some embodiments, the vectorscope representation is a plot of each pixel in the image. The plot is based on two chrominance component values (e.g., C_{b} and Cᵣ) of each pixel in the image. The plot is displayed on a two dimensional scope that spans all allowable values of the chrominance components. While the examples of chrominance components described herein use C_{b} and Cᵣ of a YC_{b}Cᵣ color system, applications with vectorscopes that plot other chrominance components of other color component spaces (e.g., U and V of a YUV color space, etc.) are within the scope of the invention. In FIG. 4A an example of such a vectorscope representation is shown as vectorscope representation 412 (i.e., the rectangle on the vectorscope 413).

The process 300 then receives (at 315) a selection of a location in an image. An example of this is shown in stage 401, as cursor 414 is selecting part of a face 416 in the image 410. The process 300 then displays (at 320) a color marker on the vectorscope representing chrominance component values of the selected location. In stage 401, the application is displaying, on the vectorscope, a color marker 418 representing the color of the selected location (here, the chrominance component values are C_{b} and Cᵣ values). In some embodiments, color indicator line 419 representing a constant ratio of chrominance component values is drawn from the center of the vectorscope to the color marker 418.

The process then determines (at 325) whether a command to rotate the vectorscope representation has been received. In stages 402-404 an example of such a command is illustrated. In the embodiments of FIG. 4A, the cursor 414 clicks (in stage 402) and drags (in stages 403 and 404) on the color marker 418. In particular, the cursor 414 drags the color marker 418 around the center of the vectorscope. In the embodiments of FIG. 4A, dragging the color marker 418 around the vectorscope commands a rotation. In other embodiments, other operations by cursors or other control devices commands a rotation of the vectorscope representation (e.g., left and right arrow keys on a keyboard, a rotating motion on a multi-touch sensitive device, etc.)

When the process 300 determines (at 325) that a command to rotate the vectorscope representation has been received, the process rotates (at 330) the vectorscope representation of the image and adjusts the colors of the image accordingly. An example of rotation of a vectorscope representation 412 is shown in stages 403-404. In stage 403, the vectorscope representation of the image has been rotated 46 degrees. In some embodiments, the rotation of the vectorscope representation 412 is shown on the vectorscope. In the embodiments of FIG. 4A, the original chrominance component values of the selected location are identified by an original location color marker 432. In some embodiments, the application also displays an original color indicator line 434 that indicates the original location (i.e., before rotation of the vectorscope representation) of the color indicator line 419. In some such embodiments, the amount of rotation of the vectorscope representation is shown by a curve 436 marked with an angle (here 46 degrees). In stage 404, the curve 436 has increased and the angle marking has increased to 95 degrees.

In conjunction with the rotation of the vectorscope representation 412 of the image, the embodiments of the application illustrated in FIG. 4A also rotate the colors of the image as indicated by the rotation of the vectorscope representation. In stage 402, the face 416 is a blue color; the cloud 417 is a white color. The color of the selected location in the face is indicated by color marker 418, which is near the blue corner of the vectorscope 413. There is no similar indication on the vectorscope of the color of the cloud 417, but if the cloud 417 had been selected, the color marker would be at the center of vectorscope 413 because the cloud is a completely neutral white (i.e., the C_{b} and Cᵣ component values for the pixels of the cloud are zero). As the vectorscope representation 412 rotates, and the color marker 418 moves near the magenta corner of the vectorscope 413, in stage 403, the face 416 turns from blue to magenta. Similarly, as the color marker moves past the red corner of the vectorscope 413 and slightly toward the yellow corner of the vectorscope 413, the face 416 turns an orange-red color. Although the color of the face 416 has changed, the color of the cloud 417 remains white because color rotation does not affect the colors of pixels with C_{b} and Cᵣ values of zero.

After rotating the vectorscope representation or when the process 300 determines (at 325) that no command to rotate the vectorscope representation has been received, the process 300 determines (at 335) whether a command to rescale the vectorscope representation has been received. When a command to rescale the vectorscope representation has been received (at 335) the process 300 rescales (at 340) the vectorscope and adjusts the colors of the image accordingly.

FIG. 4B is shown in 4 stages 405-408. Stages 405-406 show an example of the rescaling of a vectorscope representation 412 of some embodiments. The cursor 414 drags the color mark 418 toward the center of the vectorscope 413. The vectorscope representation 412 shrinks in both directions in accord with the reduction of the distance of the color mark 418 from the center of vectorscope 413. In stage 406, the reduction in the distance of the color mark 418 from the center of the vectorscope 413 is indicated by (1) a curve 436 which connects color mark 418 with a place on the original color indicator line 434 (here, the connection between curve 436 and color indicator line 434 is closer to the center than original color indicator mark 432 is to the center, indicating that the vectorscope representation has shrunk) and (2) by a percentage value 450 along color indicator line 419. In stage 405 the percentage value 450 is 100 and in stage 406 the percentage value 450 is 47. In some embodiments, the percentage value 450 is displayed over the vectorscope representation and color indicator line 419 in a different color than the vectorscope representation and/or the color indicator line. The percentage value indicates what percentage of the original distance of the reference color from the center of the vectorscope 413 remains after rescaling the vectorscope representation. In accord with the move of the color mark 418 toward the center of the vectorscope 413, the color of the face 416 changes from saturated orange-red in stage 405 to pale orange-red in stage 406. Although the color of the face 416 has changed, the color of the cloud 417 remains white because color rescaling about the center of the vectorscope does not affect the colors of pixels with C_{b} and Cᵣ values of zero.

After rescaling (at 340) the vectorscope representation, or when the determination (at 335) was that there was no command to rescale the vectorscope representation, the process 300 of FIG. 3 determines (at 345) whether a command has been received to translate (i.e., to move without rotating or rescaling) the vectorscope representation. When the process determines (at 345) that a command to translate the vectorscope representation has been received then the process 300 translates (at 350) the vectorscope representation in the direction received in the command and adjusts (at 350) the colors of the image accordingly.

Stages 407-408 of FIG. 4B show an example of translation of a vectorscope representation and the color change of the image in response to the translation. The translation (here a displacement sideways) of the vectorscope representation 412 moves the entire representation 412 over, rather than rotating the vectorscope representation 412 about the center of the vectorscope.

Because there was no translation in the previous stages, the rotation of the vectorscope representation 412 exactly matched the rotation of the reference mark about the center of the vectorscope. Accordingly, in the previous stage 406, the curve 436 represented both the rotation of the entire vectorscope representation 412 and the rotation of the color mark 418 about the center of the vectorscope. Once translation is introduced (as in stage 408) the rotation of the vectorscope representation 412 and the rotation of the color mark 418 are no longer identical. Therefore, the curve can represent one or the other, but not both. In the illustrated embodiment, the curve 436 in stage 408 represents the rotation of the color mark 418. However, in other embodiments, the application provides a curve that identifies the rotation of the vectorscope representation. In stage 408, the curve 436 goes from the color mark 418 to original color indicator line 434. In stage 408, the curve 436 indicates a color rotation of the reference color of 132 degrees even though the vectorscope representation remains rotated 95 degrees from its original orientation.

Similar to the case for the curve 436, in stage 406, the percentage value 450 represented both the change in size of the vectorscope representation and the relative change in the distance of the color mark 418 from the center of the vectorscope. In the absence of translation of the vectorscope representation 412, the rescaling was proportionate to the change in the distance of the color mark 418 from the center of the vectorscope. Translation of the vectorscope representation eliminates this relationship. Accordingly, in stage 408, the percentage value 450 represents the relative change in the distance of the color mark 418 from the center of the vectorscope. The percentage value 450 no longer represents the rescaling of the vectorscope representation as a whole. Accordingly, the percentage value 450 now shows a value of 95.

As a result of the translation of the vectorscope representation 412 the color of the face 416 has changed to a saturated yellow in stage 408. In the case of this translation, all colors of the image have been dragged toward the yellow corner of the vectorscope. Accordingly, the color of the cloud 417 changes from white in stage 407 to pale yellow in stage 408. The cloud no longer remains white because color translation does affect the colors of all pixels, including pixels with C_{b} and Cᵣ values of zero.

In the embodiment of FIG. 4B, the command to translate the vectorscope representation 412 is performed by selecting the center of the vectorscope 413 with a cursor 414 and dragging it to another location on the vectorscope. However, in other embodiments, the command to translate the vectorscope representation may be performed by other actions. For example, in some embodiments, clicking and dragging anywhere on the vectorscope other than the representative color marker will cause the vectorscope representation to translate in the direction of the drag. In other embodiments, touches on a touch-sensitive screen or activating keys on a keyboard may command the vectorscope representation to translate.

Once the process 300 of FIG. 3 translates (at 350) the vectorscope representation and adjusts the colors of the image, or when the process determines (at 345) that no command to translate the vectorscope representation has been received, the process determines (at 355) whether any further commands have been received (e.g., the process waits for further commands to adjust the image until the image is closed, the application is closed, or something else interrupts the wait for further commands). If further commands are received, the process 300 returns to operation 325 to start determining what command has been received. If the process does not receive any further commands, the process 300 ends.

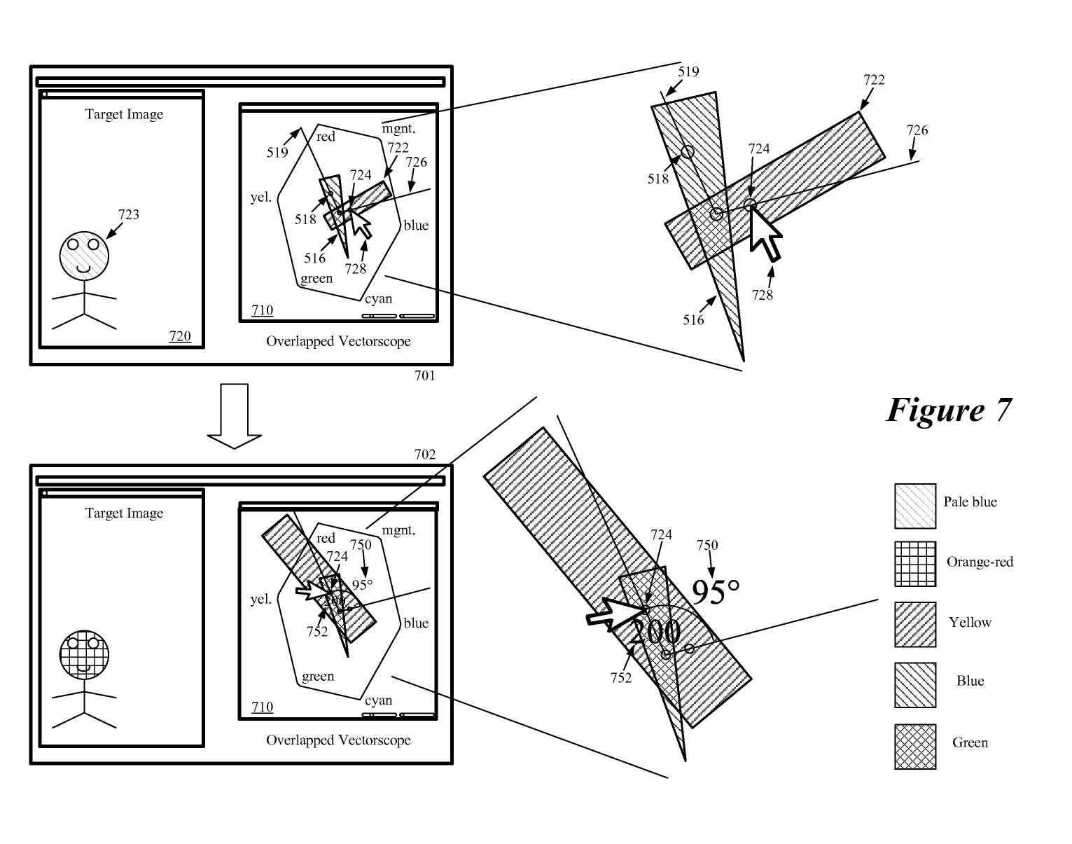

While the above described figures show rotation, rescaling, and translation of the vectorscope representation as three separate operations, in some embodiments (e.g., the embodiment of FIG. 7, described below), both rotation and rescaling can be performed simultaneously. In some such embodiments, the color mark identifying the reference color can be moved freely within the vectorscope and both the rescaling and rotation of the vectorscope representation will be determined by the position in the vectorscope to which the color mark is moved. Similarly, some embodiments provide controls for simultaneously rotating and translating the vectorscope representation. Some embodiments provide controls for simultaneously rescaling and translating the vectorscope representation. Some embodiments provide controls for performing all three operations simultaneously.

In contrast to applications of some embodiments that provide controls for simultaneously performing two or more operations, applications of some other embodiments provide a secondary control for locking out one or more of the operations while performing the other operations. In some such embodiments in which the application allows the color mark to be dragged freely through the vectorscope by a cursor device, some other control(s) (e.g., a toggle control or a key on the keyboard) can be used to lock out one degree of freedom. For example, in some embodiments, holding a particular key while dragging the color mark restricts the application to rotating the vectorscope representation without rescaling the vectorscope representation or holding a particular key while dragging the color mark restricts the application to rescaling the vectorscope representation without rotating it.

### II. Overlapped Vectorscope

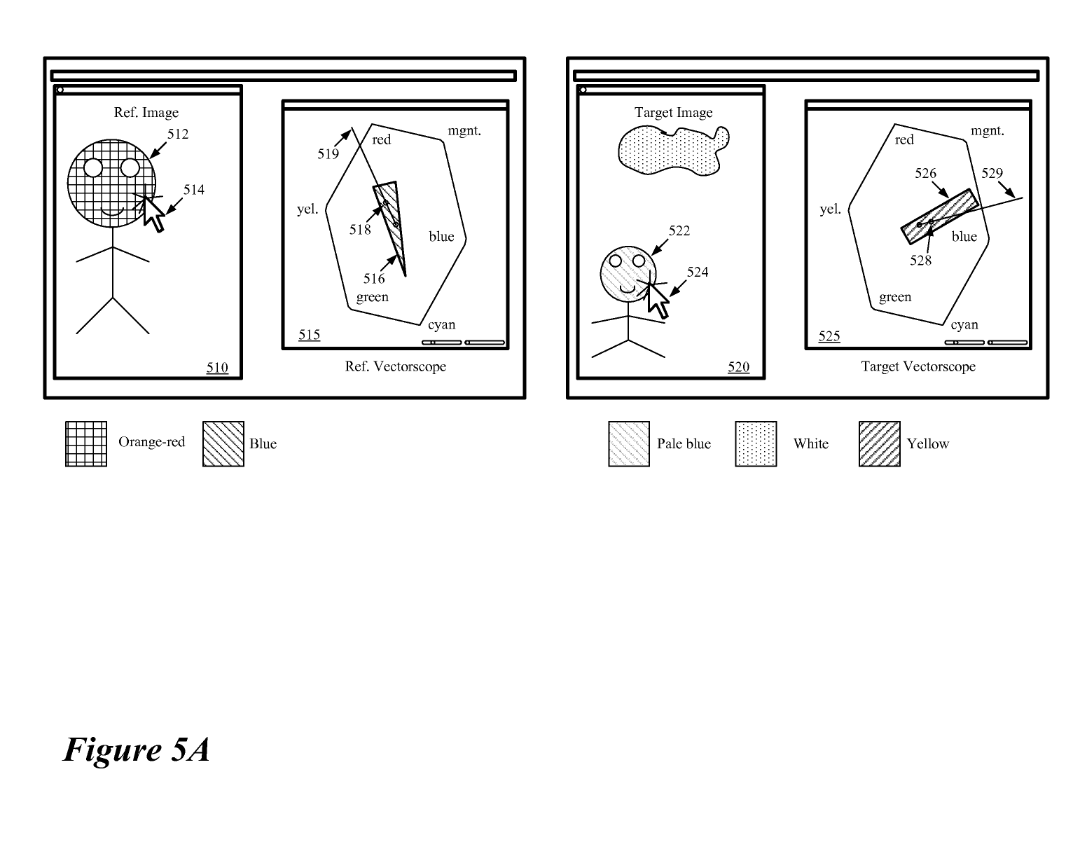

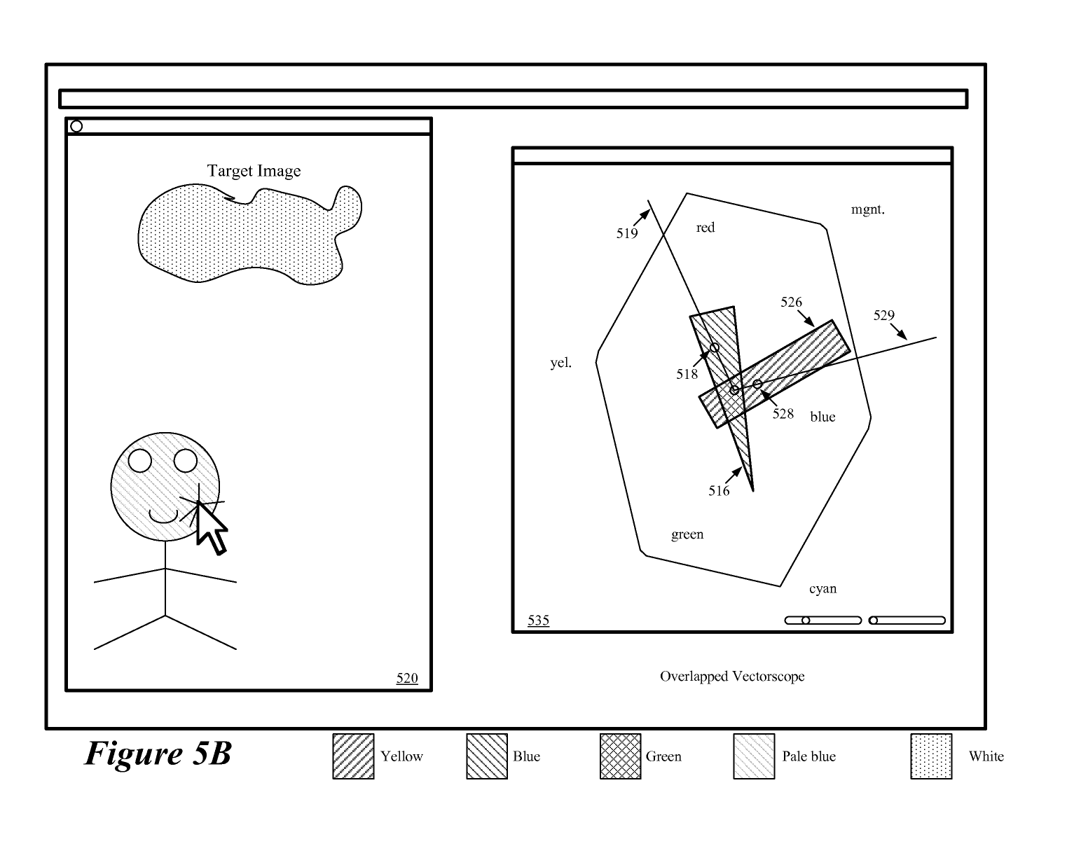

As mentioned above with respect to FIG. 1, in some embodiments, the image editing, viewing, and organizing applications provide vectorscopes that display vectorscope representations of both a reference image and a target image simultaneously. FIG. 5A illustrates an application of some embodiments displaying separate vectorscope representations of a reference image and a target image. FIG. 5B illustrates an application with an overlapped vectorscope of some embodiments. FIG. 5A includes reference image 510, reference vectorscope 515, target image 520, and target vectorscope 525. Reference image 510 includes face 512 and cursor 514. Vectorscope 515 includes vectorscope representation 516, color mark 518, and color line 519. Target image 520 includes face 522 and cursor 524. Vectorscope 525 includes target vectorscope representation 526, color mark 528, and color line 529. FIG. 5A, including reference image 510, and vectorscope representation 516 will be referred to later with respect to FIG. 7.

In the embodiment of FIG. 5A, the images 510 and 520 can be any type of color digital images. The face 512 is part of image 510. The cursor 514 is an indicator of a location on the image 510 that is being selected. The vectorscope 515 is an area that represents the set of possible C_{b} and Cᵣ component color values for pixels in an image. The reference vectorscope representation 516 is a plot of the actual pairs of C_{b} and Cᵣ values in the image 510. Color mark 518 identifies the C_{b} and Cᵣ component color values of the location in image 510 selected by cursor 514. Color line 519 identifies the set of points on the vectorscope 515 that have the same ratio of C_{b} to Cᵣ values as the selected location. Similarly, the face 522 is part of image 520. The cursor 524 is an indicator of a location on the image 520 that is being selected. The vectorscope 525 is an area that represents the set of possible C_{b} and Cᵣ component color values for pixels in an image. The target vectorscope representation 526 is a plot of the actual pairs of C_{b} and Cᵣ values in the image 520. Color mark 528 identifies the C_{b} and Cᵣ component color values of the location in image 520 selected by cursor 524. Color line 529 identifies the set of points on the vectorscope 525 that have the same ratio of C_{b} to Cᵣ values as the selected location.

In some embodiments, the reference vectorscope representation 516 represents a plot of each unique pair of C_{b} and Cᵣ component values of pixels in the image. However, due to the scale of the plot and the fact that multiple pixels in the image may have the same pair of C_{b} and Cᵣ component values as each other (e.g., be the same color or differ only in the Y component of the YC_{b}Cᵣ component values) the displayed vectorscope representation in some embodiments does not include a separate point for each pixel in the image.

Cursor 514 is clicking on face 512 identifying a specific location (e.g., a particular pixel in the image 510). The C_{b} and Cᵣ values of that location are determined and a color mark 518 is displayed on the reference vectorscope representation 516 to indicate the C_{b} and Cᵣ values of the selected location. In some embodiments, the displayed image 510 is shown using fewer pixels than the data of the image provide (e.g., a 1024×768 image may be shown in a window that is 512 pixels by 384 pixels, with each displayed pixel showing an average color of the four data pixels that the displayed pixel represents). The image editing, viewing, and organizing applications of some embodiments select a particular pixel from the image data underlying the displayed pixel selected by cursor 514. In other embodiments, the application uses C_{b} and Cᵣ values that are an aggregate of the C_{b} and Cᵣ values of the underlying pixel data.

Similarly, in some embodiments, the target vectorscope representation 526 represents a plot of each unique pair of C_{b} and Cᵣ component values of pixels in the image. However, due to the scale of the plot and the fact that multiple pixels in the image may have the same pair of C_{b} and Cᵣ component values as each other (e.g., be the same color or differ only in the Y component of the YC_{b}Cᵣ component values) the displayed vectorscope representation in some embodiments does not include a separate point for each pixel in the image.

Cursor 524 is clicking on face 522 identifying a specific location (e.g., a particular pixel in the image 520). The C_{b} and Cᵣ values of that location are determined and a color mark 528 is displayed on the target vectorscope representation 526 to indicate the C_{b} and Cᵣ values of the selected location. In some embodiments, the displayed image 520 is shown using fewer pixels than the data of the image provide (e.g., a 1024×768 image may be shown in a window that is 512 pixels by 384 pixels, with each displayed pixel showing an average color of the four data pixels that the displayed pixel represents). The image editing, viewing, and organizing applications of some embodiments select a particular pixel from the image data underlying the displayed pixel selected by cursor 524. In other embodiments, the application uses C_{b} and Cᵣ values that are an aggregate of the C_{b} and Cᵣ values of the underlying pixel data.

In some embodiments, once a reference image 510 has been selected, viewing another image 520 causes the application to automatically display an overlapped vectorscope containing both reference vectorscope representation 516 and target vectorscope representation 526. In other embodiments, an overlapped vectorscope is displayed only after a command to display an overlapped vectorscope is received (e.g., after a location in the target image 520 is selected). In some embodiments, the reference vectorscope representation 516 is displayed in a first color (in FIGS. 5A and 5B, the color blue, represented by a pattern of top left to bottom right stripes) while the target vectorscope representation 526 is displayed in a second color (in FIGS. 5A and 5B, the color yellow, represented by a pattern of top right to bottom left stripes).

In some embodiments, both vectorscope representations 516 and 526 are displayed on a single, overlapped vectorscope. FIG. 5B illustrates an overlapped vectorscope 535 of some embodiments. In the embodiment of FIG. 5B, the image 520 (the target image) is displayed while image 510 (the reference image) is not shown. However, in some embodiments, both images (e.g., side by side) or part of one image and all of another (e.g., in overlapping image windows) are shown simultaneously. Overlapped vectorscope 535 displays both reference vectorscope representation 516 and target vectorscope representation 526. In the embodiment of FIG. 5B the overlapped vectorscope 535 also displays both sets of color indicators (color marks 518 and 528 and color lines 519 and 529). However, in some embodiments, the overlapped vectorscope displays the color mark 528 and color line 529 from the target image, but does not display the color mark 518 and color line 519 from the reference image. In some embodiments, there is no requirement that a user select a color reference location in the reference image or in the target image. The applications of some embodiments display both vectorscope representations 516 and 526, but do not display color marks 518 and 528 or color lines 519 and 529.

In the illustrated embodiment, the vectorscope representations 516 and 526 are each shown as having a different color. Specifically, reference vectorscope representation 516 is shown as being blue, while target vectorscope representation 526 is shown as being yellow. In the illustrated embodiment, the overlapping section 536 of the vectorscope representations 516 and 526 are shown as being a third color, specifically green. However, in some embodiments, the overlapping sections of vectorscope representations are the color of the target vectorscope representation. In other embodiments the overlapping sections of vectorscope representations are the color of the reference vectorscope representation.

While the stylized vectorscope representations used throughout this application are different identifiable shapes (a rectangle and a triangle), the vectorscope representations of real images would generally be amorphous shapes that could not be easily distinguished from one another if they were plotted on the same vectorscope in the same color or with the same color scheme (e.g., with colors based on the location of each point on the vectorscope). However, in some embodiments, the reference vectorscope representation and the target vectorscope representation are displayed in the same color or in the same color scheme. In some embodiments, the application provides a setting that the user can activate to determine whether to use different colors for each vectorscope representation or use a common color (or common color scheme) for both vectorscope representations.

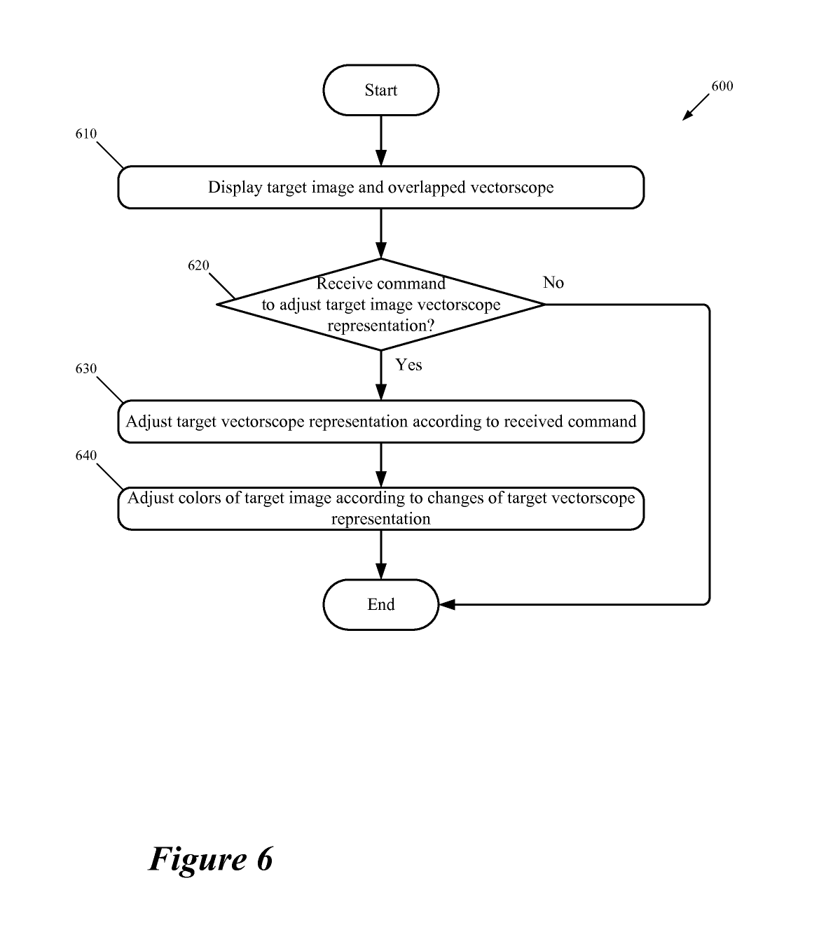

FIG. 6 conceptually illustrates a process 600 of some embodiments for displaying an overlapped vectorscope while adjusting an image. The process 600 displays (at 610) a target image and an overlapped vectorscope. In some embodiments, the overlapped vectorscope is automatically displayed once both a reference image and a target image are selected. In other embodiments, the application displays a vectorscope representation of the target image in the vectorscope until the user activates a control commanding that the vectorscope display both the target vectorscope representation and the reference vectorscope representation.

The process 600 then determines (at 620) whether it has received a command to adjust the target image vectorscope representation. If no command is received then the process 600 ends. If a command is received, the process 600 adjusts (at 630) the vectorscope representation according to the received command. In some embodiments, the received command can be a command to rotate the vectorscope representation, to rescale the vectorscope representation, or to translate the vectorscope representation. The received command can also be to perform more than one type of operation in some embodiments.

The process 600 then adjusts (at 640) the colors of the image according to the changes of the target vectorscope representation. For example, if the command is to rotate the vectorscope representation, then the process 600 rotates the colors of the image. Similarly, if the command is to rescale the vectorscope representation then the process 600 multiplies the chrominance component values (e.g., C_{b} and Cᵣ) of the image by a rescaling factor.

Not all chrominance component values (e.g., C_{b} and Cᵣ in a YC_{b}Cᵣ color space) are compatible with all luminance values (e.g., Y values in a YC_{b}Cᵣ color space). As the luminance values approach the extreme ends of the scale (i.e., as a pixel becomes very bright or very dark), the range of chrominance component values (e.g., C_{b} and Cᵣ) consistent with that luminance value (e.g., Y) shrinks. Accordingly, it is not always possible to increase the chrominance component values without changing the luminance value. Therefore, in some embodiments, when adjusting the chrominance component values (e.g., C_{b} and Cᵣ) the process 600 also adjusts luminance (e.g., Y) values of the pixels (e.g., when the chrominance components C_{b} and Cᵣ of a pixel become too large to be consistent with the previous Y component value of the pixel).

FIG. 7 illustrates the adjustment of an image in response to a command to adjust a target vectorscope representation. The figure is shown in two stages 701-702. Stage 701 includes vectorscope 710, reference vectorscope representation 516, color mark 518, color line 519, target image 720, target vectorscope representation 722, face 723, color mark 724, color line 726 and cursor 728. For clarity, the vectorscope representations 516 and 722 are shown in both overlapped vectorscope 710, and an enlarged view 740. In the embodiments of FIG. 7, the application also displays, in stage 702 on the vectorscope 710, a curve 750 with an angle indicator, and a percentage value 752.

As mentioned above, some objects in FIG. 7 are related to objects in FIG. 5A. The vectorscope representation 516 represents image 510 (not shown in FIG. 7) of FIG. 5A, the color mark 518 represents a selected location in the face 512 (not shown in FIG. 7) of the image 510 in FIG. 5A. The vectorscope representation 722 represents the image 720 of FIG. 7, the color mark 724 represents a selected location in the face 723 of the image 720 in FIG. 5A.

The vectorscope representations 516 and 722 are each shown with patterns representing colors (blue and yellow, respectively) with their overlapping region in each stage shown in a third color (green). In stage 701, the cursor 728 selects color mark 724 and in stage 702 the cursor has dragged the color mark 724 to the same location as color mark 518. In the embodiments of FIG. 7, dragging the color mark 724 to a new location rotates and/or rescales the vectorscope representation 722 in such a way as to keep the color mark 724 in the same relationship with the vectorscope representation. For example, if the color mark 724 is originally one third of the way from one end of the vectorscope representation 722 in one direction and in the middle of the vectorscope representation 722 in the other direction before the color mark is moved, then the vectorscope representation 722 will rotate and rescale such that the color mark 724 will be one third of the way from one end of the vectorscope representation 722 in one direction and in the middle of the vectorscope representation 722 in the other direction after the color mark is moved.

The new location of the color mark 724 is in an orange-red portion of the vectorscope 710. Accordingly, the location in face 723 represented by the color mark 724 changes to the color represented by the new location of the color mark 724, which in this example is the same location as the color mark 518 representing a location in the face 512 of FIG. 5A.

The angle indicator of curve 750 shows the user the angle through which the vectorscope representation 722 has been rotated about the center of vectorscope 710 as a result of the movement of color mark 724. The percentage value 752 shows the user the percentage value 752 of the rescaling factor that the application has applied to the vectorscope representation 722 as a result of the movement of color mark 724. In the embodiments of FIG. 7 before the color mark 724 has moved, the curve 750, its angle indicator, and percentage value 752 are not shown. However, the applications of some embodiments display a percentage value 752 of 100 and an angle indicator of 0 degrees before the color mark is moved.

Although the embodiments of FIG. 7 display a color mark 518 and color line 519 for the reference image, some embodiments do not show a color mark and color line for the reference image on an overlapped vectorscope. Similarly, some embodiments provide overlapping vectorscopes, with a reference vectorscope representation and a target vectorscope representation, but without any color marks or color lines.

FIG. 7, in stage 702 shows a color mark 724 of the target image 720 that has been manually moved to the same location as the color mark 518 of the reference image. The movement of the color mark 724 has the effect of setting the pixel of the selected location of the target image (and pixels with the same chrominance values as the selected pixel) to the same values of chrominance components (e.g., C_{b} and Cᵣ) as the selected location of the reference image. The applications of some embodiments provide a control for automatically setting the values of chrominance components (e.g., C_{b} and Cᵣ) of a selected location in a target image to the same values as the chrominance components of a selected location in the reference image.

In some embodiments, activating the control also rotates the colors of the target image and/or rescales them consistent with the change of the selected color. In some embodiments, activating the control causes the vectorscope representation to rotate and moves a color mark representing a location in a target image to the color mark representing the location in the reference image.

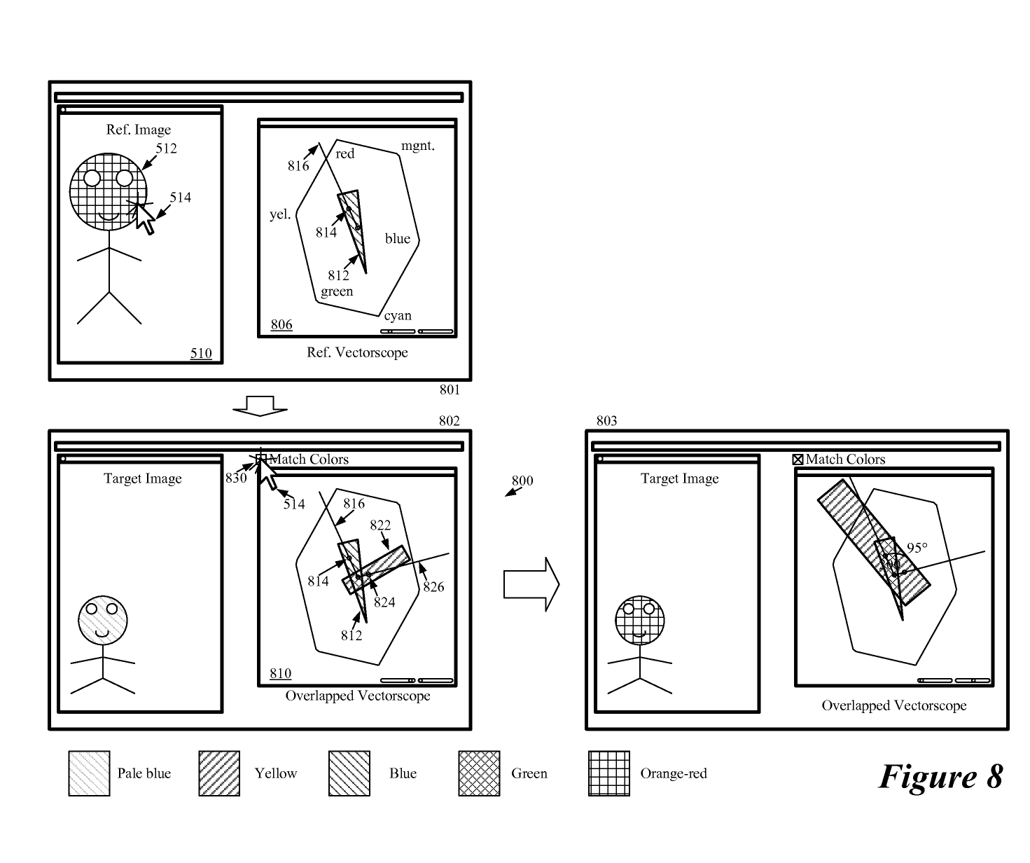

FIG. 8 illustrates a GUI 800 of an application of some embodiments that provides a control for automatically synchronizing chrominance components (e.g., C_{b} and Cᵣ). The figure is shown in three stages 801, 802, and 803 with image 805 adjusted from stage 802 to stage 803. In stage 801, a cursor 514 selects a location on face 512 of image 510. A vectorscope 806 displays reference vectorscope representation 812, which represents the chrominance values of the pixels of image 510. The reference vectorscope representation 812 includes color mark 814 and color line 816.

Between stages 801 and 802, a user selects a target image and selects a location in a face in the target image as a reference location. Accordingly, in stage 802, a vectorscope 810 displays reference vectorscope representation 812 and target vectorscope representation 822. The reference vectorscope representation 812 includes color mark 814 and color line 816. The target vectorscope representation 822 includes color mark 824 and color line 826. The GUI 800 also provides a color match control 830, which is activated in stage 802 by cursor 514.

In stage 803, the application has automatically rotated and rescaled target vectorscope representation 822 to set color mark 824 to the same location as color mark 814. The colors in image 805 have also been adjusted accordingly. One of ordinary skill in the art will realize that in some embodiments, the color match control 830 sets the chrominance component values (e.g., C_{b} and Cᵣ) of the selected location of the target image 805 to the same chrominance component values as the selected location of the reference image, but does not adjust the luminance values (e.g., Y) of the target pixel to match the luminance value of the reference pixel. In other embodiments, the color match control does adjust the luminance value of the target pixel to match the luminance value of the reference pixel.

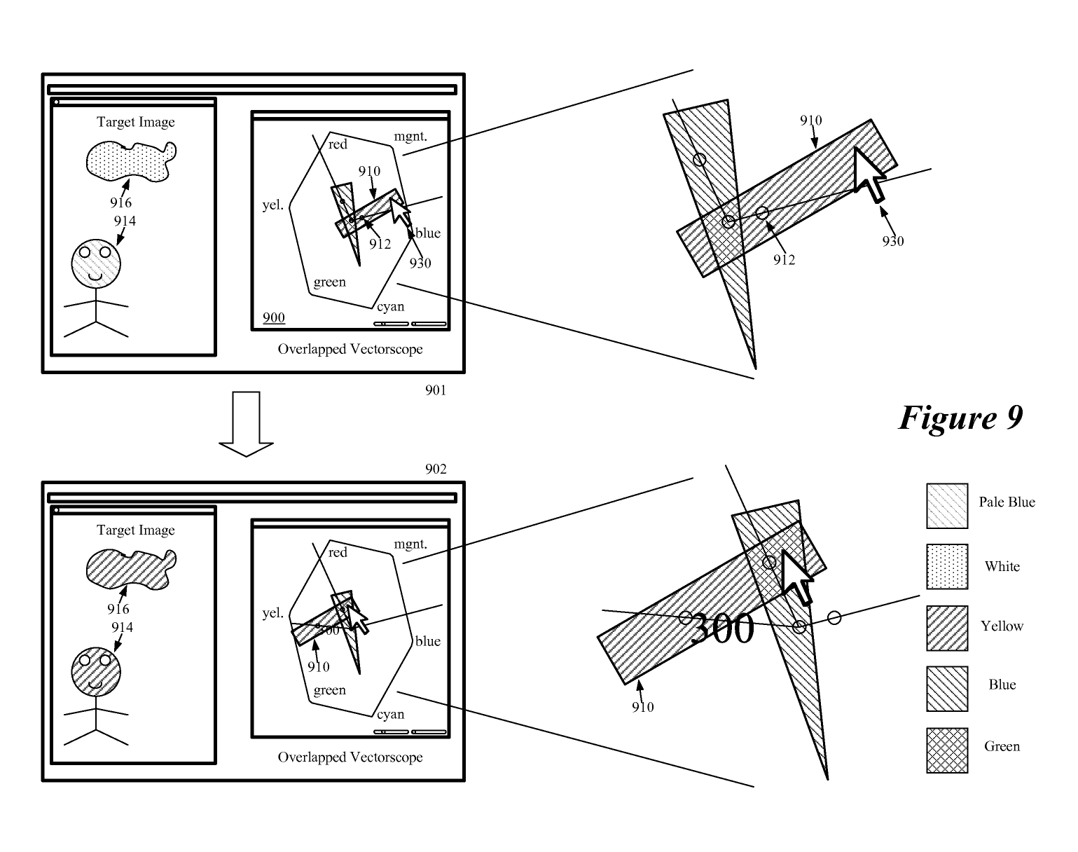

The applications of some embodiments rotate and rescale vectorscope representations on an overlapped vectorscope. Similarly, the applications of some embodiments translate the vectorscope representation as directed by a user. FIG. 9 illustrates the use of an overlapped vectorscope 900 to receive a command to translate a vectorscope representation laterally. FIG. 9 is shown in two stages 901-902. In stage 901, a cursor 930 selects a point on a target vectorscope representation 910 on vectorscope 900. The selected point is a point not on the color marker 912 of the target vectorscope representation 910. The cursor 930 then drags the target vectorscope representation 910 to the left (toward the yellow corner of the vectorscope 900) in stage 902. The target vectorscope representation 910 is dragged so far that both pale blue face 914 and white cloud 916 turn yellow in stage 902. In the embodiment of FIG. 9, other than the overlapping vectorscope representations, the details of the translation closely follow those shown in stages 407 and 408 of FIG. 4B.

### III. Vectorscope Display Controls

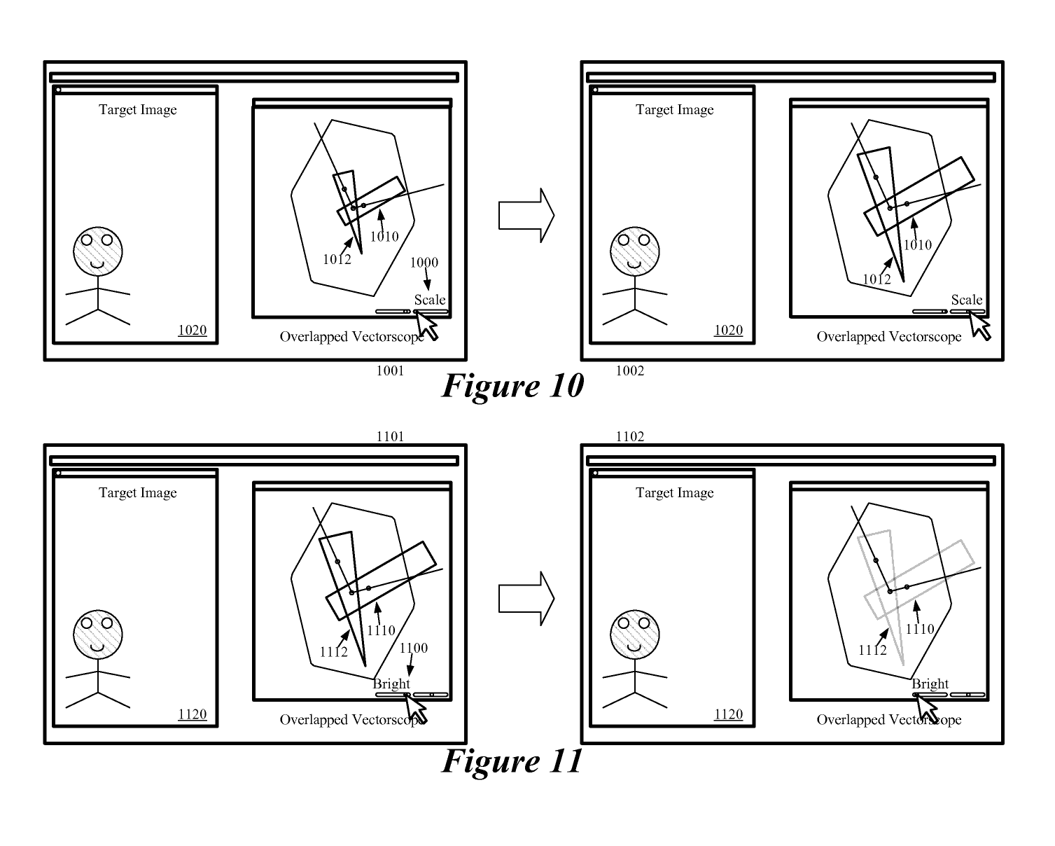

The applications of some embodiments provide additional controls for adjusting the display of an overlapped vectorscope without changing the colors of the image. FIG. 10 illustrates a control 1000 for visually rescaling (i.e., zooming in on) the vectorscope representations. The control 1000 resizes the vectorscope representations 1010 and 1012 without adjusting any of the values of the vectorscope representations 1010 and 1012 or the colors of the image 1020. In stage 1001, the control 1000 is selected and in stage 1002 the control 1000 is adjusted to a higher setting. Accordingly, the vectorscope representations 1010 and 1012 both change size. The change is size is a result in the change of the display scale, not a result of a change in the values of the vectorscope representations 1010 and 1012. Accordingly, the image 1020 is unchanged from stage 1001 to stage 1002.

In some embodiments, the name of the control 1000 is displayed under some circumstances, but is not displayed in other circumstances. In the illustrated embodiments of FIG. 10, the name, “Scale”, of control 1000 is visible when the control is in use or when the cursor is hovering over the control. In the illustrated embodiment, the control 1000 is shown as a slider control, but in some embodiments, other types of controls are used to zoom in on the vectorscope representations.

FIG. 11 illustrates a control 1100 for adjusting the brightness of the vectorscope representations. The control 1100 dims or brightens the vectorscope representations 1110 and 1112 without adjusting any of the values of the vectorscope representations 1110 and 1112 or the colors of the image 1120. In stage 1101, the control 1100 is selected and in stage 1102 the control 1100 is adjusted to a lower setting. Accordingly, the vectorscope representations 1110 and 1112 both become dimmer. The change in brightness of the vectorscope representations 1110 and 1112 does not affect the values of the vectorscope representations 1110 and 1112. Accordingly, the image 1120 is unchanged from stage 1101 to stage 1102.

In some embodiments, the name of the control 1100 is displayed under some circumstances, but is not displayed in other circumstances. In the illustrated embodiments of FIG. 11, the name, “Bright”, of control 1100 is visible when the control is in use or when the cursor is hovering over the control. In the illustrated embodiment, the control 1100 is shown as a slider control, but in some embodiments, other types of controls are used to zoom in on the vectorscope representations.

### IV. Mobile Device

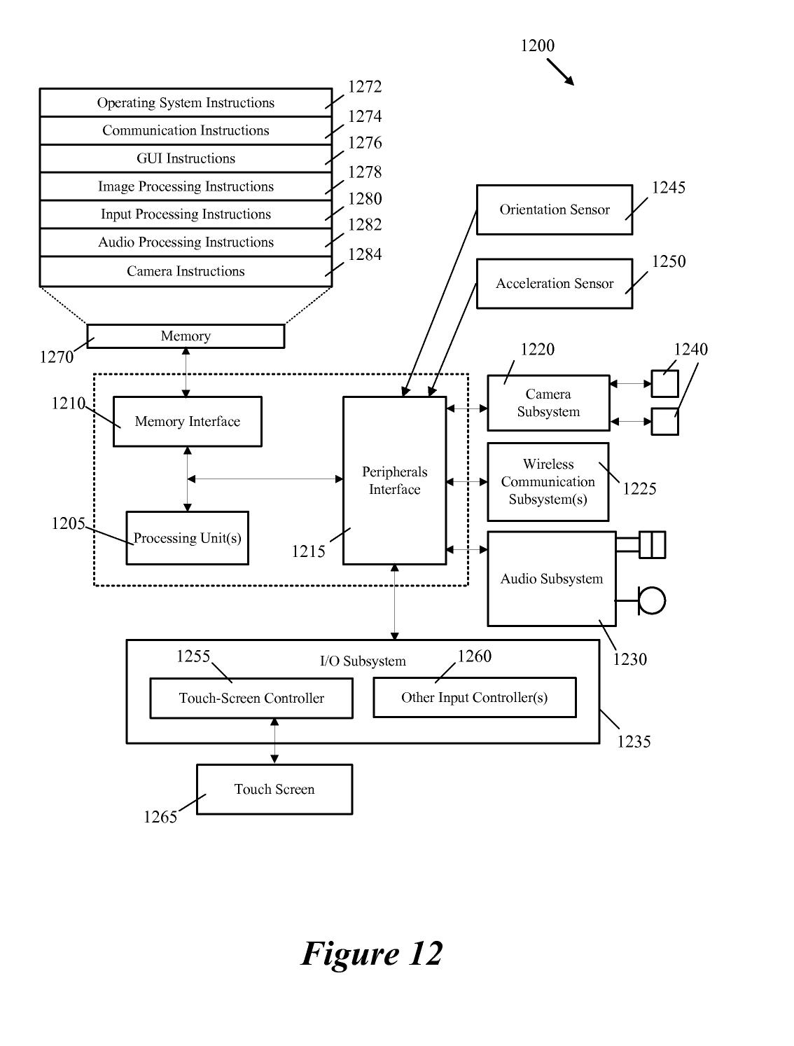

The image organizing, editing, and viewing applications of some embodiments operate on mobile devices, such as smartphones (e.g., iPhones®) and tablets (e.g., iPads®). FIG. 12 is an example of an architecture 1200 of such a mobile computing device. Examples of mobile computing devices include smartphones, tablets, laptops, etc. As shown, the mobile computing device 1200 includes one or more processing units 1205, a memory interface 1210 and a peripherals interface 1215.

The peripherals interface 1215 is coupled to various sensors and subsystems, including a camera subsystem 1220, a wireless communication subsystem(s) 1225, an audio subsystem 1230, an I/O subsystem 1235, etc. The peripherals interface 1215 enables communication between the processing units 1205 and various peripherals. For example, an orientation sensor 1245 (e.g., a gyroscope) and an acceleration sensor 1250 (e.g., an accelerometer) is coupled to the peripherals interface 1215 to facilitate orientation and acceleration functions.

The camera subsystem 1220 is coupled to one or more optical sensors 1240 (e.g., a charged coupled device (CCD) optical sensor, a complementary metal-oxide-semiconductor (CMOS) optical sensor, etc.). The camera subsystem 1220 coupled with the optical sensors 1240 facilitates camera functions, such as image and/or video data capturing. The wireless communication subsystem 1225 serves to facilitate communication functions. In some embodiments, the wireless communication subsystem 1225 includes radio frequency receivers and transmitters, and optical receivers and transmitters (not shown in FIG. 12). These receivers and transmitters of some embodiments are implemented to operate over one or more communication networks such as a GSM network, a Wi-Fi network, a Bluetooth network, etc. The audio subsystem 1230 is coupled to a speaker to output audio (e.g., to output voice navigation instructions). Additionally, the audio subsystem 1230 is coupled to a microphone to facilitate voice-enabled functions, such as voice recognition (e.g., for searching), digital recording, etc.

The I/O subsystem 1235 involves the transfer between input/output peripheral devices, such as a display, a touch screen, etc., and the data bus of the processing units 1205 through the peripherals interface 1215. The I/O subsystem 1235 includes a touch-screen controller 1255 and other input controllers 1260 to facilitate the transfer between input/output peripheral devices and the data bus of the processing units 1205. As shown, the touch-screen controller 1255 is coupled to a touch screen 1265. The touch-screen controller 1255 detects contact and movement on the touch screen 1265 using any of multiple touch sensitivity technologies. The other input controllers 1260 are coupled to other input/control devices, such as one or more buttons. Some embodiments include a near-touch sensitive screen and a corresponding controller that can detect near-touch interactions instead of or in addition to touch interactions.

The memory interface 1210 is coupled to memory 1270. In some embodiments, the memory 1270 includes volatile memory (e.g., high-speed random access memory), non-volatile memory (e.g., flash memory), a combination of volatile and non-volatile memory, and/or any other type of memory. As illustrated in FIG. 12, the memory 1270 stores an operating system (OS) 1272. The OS 1272 includes instructions for handling basic system services and for performing hardware dependent tasks.

The memory 1270 also includes communication instructions 1274 to facilitate communicating with one or more additional devices; graphical user interface instructions 1276 to facilitate graphic user interface processing; image processing instructions 1278 to facilitate image-related processing and functions; input processing instructions 1280 to facilitate input-related (e.g., touch input) processes and functions; audio processing instructions 1282 to facilitate audio-related processes and functions; and camera instructions 1284 to facilitate camera-related processes and functions. The instructions described above are merely exemplary and the memory 1270 includes additional and/or other instructions in some embodiments. For instance, the memory for a smartphone may include phone instructions to facilitate phone-related processes and functions. Additionally, the memory may include instructions for an image organizing, editing, and viewing application. The above-identified instructions need not be implemented as separate software programs or modules. Various functions of the mobile computing device can be implemented in hardware and/or in software, including in one or more signal processing and/or application specific integrated circuits.

While the components illustrated in FIG. 12 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 12 may be split into two or more integrated circuits.

### V. Computer System

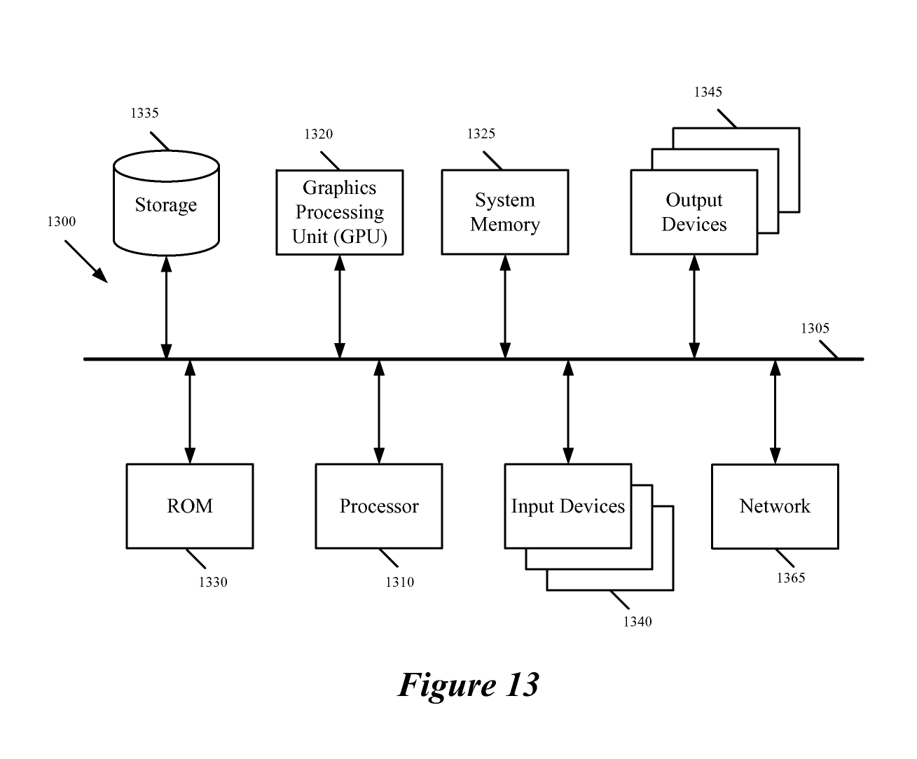

FIG. 13 conceptually illustrates another example of an electronic system 1300 with which some embodiments of the invention are implemented. The electronic system 1300 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1300 includes a bus 1305, processing unit(s) 1310, a graphics processing unit (GPU) 1315, a system memory 1320, a network 1325, a read-only memory 1330, a permanent storage device 1335, input devices 1340, and output devices 1345.

The bus 1305 collectively represents all system, peripheral, and chipset buses that communicatively connect the numerous internal devices of the electronic system 1300. For instance, the bus 1305 communicatively connects the processing unit(s) 1310 with the read-only memory 1330, the GPU 1315, the system memory 1320, and the permanent storage device 1335.

From these various memory units, the processing unit(s) 1310 retrieves instructions to execute and data to process in order to execute the processes of the invention. The processing unit(s) may be a single processor or a multi-core processor in different embodiments. Some instructions are passed to and executed by the GPU 1315. The GPU 1315 can offload various computations or complement the image processing provided by the processing unit(s) 1310.

The read-only-memory (ROM) 1330 stores static data and instructions that are needed by the processing unit(s) 1310 and other modules of the electronic system. The permanent storage device 1335, on the other hand, is a read-and-write memory device. This device is a non-volatile memory unit that stores instructions and data even when the electronic system 1300 is off. Some embodiments of the invention use a mass-storage device (such as a magnetic or optical disk and its corresponding disk drive) as the permanent storage device 1335.

Other embodiments use a removable storage device (such as a floppy disk, flash memory device, etc., and its corresponding drive) as the permanent storage device. Like the permanent storage device 1335, the system memory 1320 is a read-and-write memory device. However, unlike storage device 1335, the system memory 1320 is a volatile read-and-write memory, such a random access memory. The system memory 1320 stores some of the instructions and data that the processor needs at runtime. In some embodiments, the invention's processes are stored in the system memory 1320, the permanent storage device 1335, and/or the read-only memory 1330. For example, the various memory units include instructions for processing multimedia clips in accordance with some embodiments. From these various memory units, the processing unit(s) 1310 retrieves instructions to execute and data to process in order to execute the processes of some embodiments.

The bus 1305 also connects to the input and output devices 1340 and 1345. The input devices 1340 enable the user to communicate information and select commands to the electronic system. The input devices 1340 include alphanumeric keyboards and pointing devices (also called “cursor control devices”), cameras (e.g., webcams), microphones or similar devices for receiving voice commands, etc. The output devices 1345 display images generated by the electronic system or otherwise output data. The output devices 1345 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 13, bus 1305 also couples electronic system 1300 to a network 1325 through a network adapter (not shown). In this manner, the computer can be a part of a network of computers (such as a local area network (“LAN”), a wide area network (“WAN”), or an Intranet, or a network of networks, such as the Internet. Any or all components of electronic system 1300 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While various processes described herein are shown with operations in a particular order, one of ordinary skill in the art will understand that in some embodiments the orders of operations will be different. For example in the process 300 of FIG. 3, the determination of whether commands to rotate, rescale, or translate the vectorscope representation are shown in that order, but in other embodiments, the order of determination may be different, or may even run in parallel.

What is claimed is:

1. A method of editing colors of an image, the method comprising:
displaying, on a scope, a first representation of a set of colors of a reference image and a second representation of a set of colors of a target image;
receiving a command to adjust the second representation; and
adjusting the set of colors of the target image based on the adjustment of the second representation.

2. The method of claim 1, wherein the command to adjust the second representation is a command to rotate the second representation and adjusting the set of colors of the target image comprises performing a color rotation of the set of colors of the target image.

3. The method of claim 1, wherein the command to adjust the second representation is a command to rescale the second representation and adjusting the set of colors of the target image comprises determining a set of chromatic values for each pixel in the image and multiplying each chromatic value in the set of chromatic values by a scaling factor.

4. The method of claim 1 further comprising:
receiving a selection of a location in the target image; and
displaying a mark on the scope corresponding to the color of the selected location in the target image, wherein the command to adjust the second representation comprises receiving a selection and dragging of the mark.

5. The method of claim 4, wherein the mark is a first mark, the method further comprising:
receiving a selection of a location in the reference image; and
displaying a second mark on the scope corresponding to the color of the selected location in the reference image.

6. The method of claim 5 further comprising providing a control for rotating and rescaling the second representation to align the first mark with the second mark.

7. The method of claim 1, wherein the color values of each pixel in the reference image and the target image correspond to two chromatic component values and a luminance component value, the first representation comprises a plot of the chromatic component value pairs of each pixel in the reference image, and the second representation comprises a plot of the chromatic component value pairs of each pixel in the target image.

8. A non-transitory machine readable medium storing a program which when executed by at least one processing unit edits the colors of an image, the program comprising sets of instructions for:
displaying, on a scope, a first representation of a set of colors of a reference image and a second representation of a set of colors of a target image;
receiving a command to adjust the second representation; and
adjusting the set of colors of the target image based on the adjustment of the second representation.

9. The non-transitory machine readable medium of claim 8, wherein the command to adjust the second representation is a command to rotate the second representation and adjusting the set of colors of the target image comprises performing a color rotation of the set of colors of the target image.

10. The non-transitory machine readable medium of claim 8, wherein the command to adjust the second representation is a command to rescale the second representation and adjusting the set of colors of the target image comprises determining a set of chromatic values for each pixel in the image and multiplying each chromatic value in the set of chromatic values by a scaling factor.

11. The non-transitory machine readable medium of claim 8, the program further comprising sets of instructions for:
receiving a selection of a location in the target image; and
displaying a mark on the scope corresponding to the color of the selected location in the target image, wherein the command to adjust the second representation comprises receiving a selection and dragging of the mark.

12. The non-transitory machine readable medium of claim 11, wherein the mark is a first mark, the program further comprising sets of instructions for:
receiving a selection of a location in the reference image; and
displaying a second mark on the scope corresponding to the color of the selected location in the reference image.

13. The non-transitory machine readable medium of claim 12, the program further comprising a set of instructions for providing a control for rotating and rescaling the second representation to align the first mark with the second mark.

14. The non-transitory machine readable medium of claim 8, wherein the color values of each pixel in the reference image and the target image correspond to two chromatic component values and a luminance component value, the first representation comprises a plot of the chromatic component value pairs of each pixel in the reference image, and the second representation comprises a plot of the chromatic component value pairs of each pixel in the target image.

15. A device comprising at least one processing unit and a non-transitory machine readable medium storing a program which when executed by the processing unit edits the colors of an image, the program comprising sets of instructions for:
displaying, on a scope, a first representation of a set of colors of a reference image and a second representation of a set of colors of a target image;
receiving a command to adjust the second representation; and
adjusting the set of colors of the target image based on the adjustment of the second representation.

16. The device of claim 15, wherein the command to adjust the second representation is a command to rotate the second representation and adjusting the set of colors of the target image comprises performing a color rotation of the set of colors of the target image.

17. The device of claim 15, wherein the command to adjust the second representation is a command to rescale the second representation and adjusting the set of colors of the target image comprises determining a set of chromatic values for each pixel in the image and multiplying each chromatic value in the set of chromatic values by a scaling factor.

18. The device of claim 15, the program further comprising sets of instructions for:
receiving a selection of a location in the target image; and
displaying a mark on the scope corresponding to the color of the selected location in the target image, wherein the command to adjust the second representation comprises receiving a selection and dragging of the mark.

19. The device of claim 18, wherein the mark is a first mark, the program further comprising sets of instructions for:
receiving a selection of a location in the reference image; and
displaying a second mark on the scope corresponding to the color of the selected location in the reference image.

20. The device of claim 15, wherein the color values of each pixel in the reference image and the target image correspond to two chromatic component values and a luminance component value, the first representation comprises a plot of the chromatic component value pairs of each pixel in the reference image, and the second representation comprises a plot of the chromatic component value pairs of each pixel in the target image.
